(19) United States
(12) Patent Application Publication
(10) Pub. No.: US 2016/0321056 A1
(43) Pub. Date: Nov. 3, 2016

(54) METHODS AND APPARATUS FOR UPGRADING A PLURALITY OF DATABASES

(71) Applicant: kCura LLC, Chicago, IL (US)

(72) Inventors: Nathanial Joseph Noonen, Chicago, IL (US); Margaret Wileen Svec, Chicago, IL (US); Christopher Hogan, Lombard, IL (US); Daniel Wells, Evanston, IL (US)

(21) Appl. No.: 14/731,070

(22) Filed: Jun. 4, 2015

Related U.S. Application Data
(60) Provisional application No. 62/156,262, filed on May 2, 2015.

(51) Int. Cl. G06F 9/445

(52) U.S. Cl. CPC G06F 8/65

(57) ABSTRACT

Methods and apparatus for upgrading a plurality of databases are disclosed. For example, a computer system may receive a first upgrade order associated with a first database. The system then receives a second upgrade order associated with a second database, wherein the first upgrade order is indicative of a first higher upgrade precedence than the second upgrade order. The system then receives a first priority associated with a third database. The system then receives a second priority associated with a fourth database wherein the first priority is indicative of a second higher upgrade precedence than the second priority. The system then upgrades the first database first in time based on the first upgrade order. The system then upgrades the second database second in time based on the second upgrade order. The system then upgrades the third database third in time based on the first priority. The system then upgrades the fourth database fourth in time based on the second priority.

### RELATED APPLICATIONS

This application claims priority to Provisional Application Ser. No. 62/156,262, filed on May 2, 2015, having inventors Nathanial Joseph Noonen et al., titled “METHODS AND APPARATUS FOR UPGRADING A PLURALITY OF DATABASES”, and is incorporated herein by reference.

### TECHNICAL FIELD

The present disclosure relates in general to databases, and, in particular, to methods and apparatus for upgrading a plurality of databases.

### BACKGROUND

The vast majority of documents we create and/or archive are stored electronically. In order to quickly find certain documents, the relevant data from these documents is typically extracted, catalogued, and organized in a centralized database to make them searchable. In some circumstances, these databases can be very large. For example, a law suit may involve millions of documents. Coding documents in these large databases can be problematic. Often, these database need to be upgraded. However, upgrading a database often renders that database unusable or cumbersome for users during the upgrade period. Accordingly, a problem exists as to what order these databases should be upgraded in order to minimize user disruptions and/or downtime during the upgrade process.

### BRIEF DESCRIPTION OF THE DRAWINGS

FIG. 1 is a block diagram of an example network communication system.

FIG. 2 is a block diagram of an example computing device.

FIG. 3 is a flowchart of an example process for upgrading a plurality of databases.

FIG. 4 is a flowchart of another example process for upgrading a plurality of databases.

FIG. 5 is a flowchart of another example process for upgrading a plurality of databases.

FIG. 6 is a screen shot of an example upgrade order application showing a plurality of database upgrades.

FIG. 7 is a screen shot of an example upgrade order application showing an upgrade order overriding any prioritizations for three databases.

FIG. 8 is a screen shot of an example upgrade order application showing a user setting an upgrade order.

FIG. 9 is a screen shot of an example upgrade order application showing a user setting another upgrade order.

FIG. 10 is a screen shot of an example upgrade order application showing a user setting a priority.

FIG. 11 is a screen shot of an example upgrade order application showing a script dependency.

FIG. 12 is a screen shot of an example upgrade order application showing a maximum number of upgrade for a particular server.

FIG. 13 is a screen shot of an example upgrade order application showing a particular server being memory bound.

FIG. 14 is a screen shot of an example upgrade order application showing a particular server being memory bound.

### DETAILED DESCRIPTION OF THE PREFERRED EMBODIMENTS

Briefly, methods and apparatus for upgrading a plurality of databases are disclosed. For example, a computer system may receive a first upgrade order associated with a first database. The system then receives a second upgrade order associated with a second database, wherein the first upgrade order is indicative of a first higher upgrade precedence than the second upgrade order. The system then receives a first priority associated with a third database. The system then receives a second priority associated with a fourth database wherein the first priority is indicative of a second higher upgrade precedence than the second priority. The system then upgrades the first database first in time based on the first upgrade order. The system then upgrades the second database second in time based on the second upgrade order. The system then upgrades the third database third in time based on the first priority. The system then upgrades the fourth database fourth in time based on the second priority.

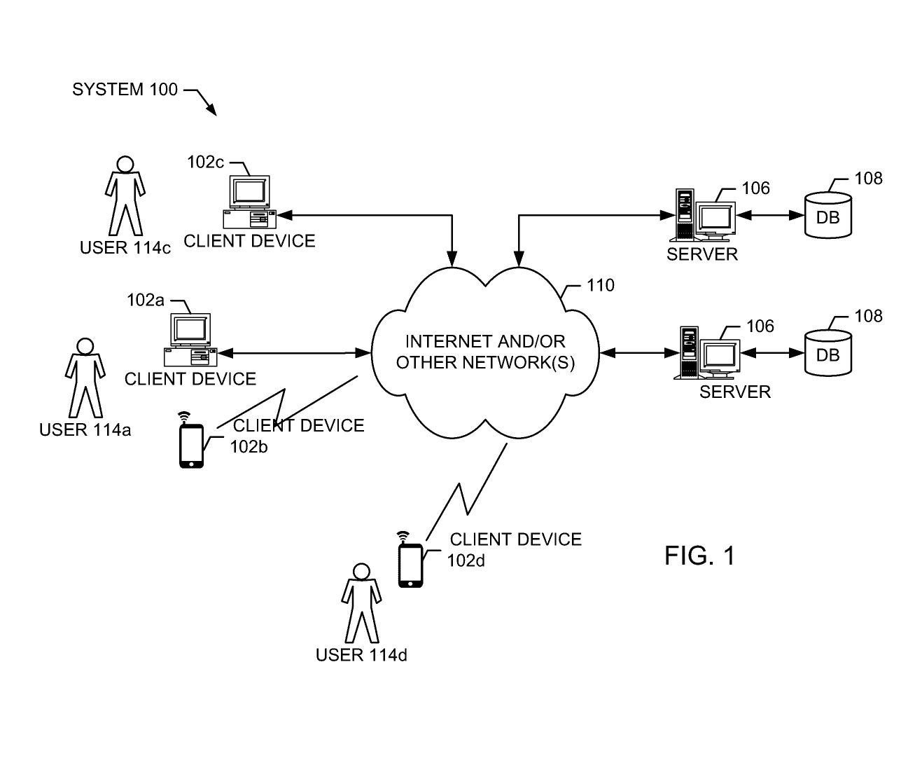

Turning now to the figures, the present system is most readily realized in a network communication system 100. A block diagram of certain elements of an example network communications system 100 is illustrated in FIG. 1. The illustrated system 100 includes one or more client devices 102 (e.g., computer, television, camera, phone), one or more web servers 106, and one or more databases 108. Each of these devices may communicate with each other via a connection to one or more communications channels 110 such as the Internet or some other wired and/or wireless data network, including, but not limited to, any suitable wide area network or local area network. It will be appreciated that any of the devices described herein may be directly connected to each other instead of over a network.

The web server 106 stores a plurality of files, programs, and/or web pages in one or more databases 108 for use by the client devices 102 as described in detail below. The database 108 may be connected directly to the web server 106 and/or via one or more network connections. The database 108 stores data as described in detail below.

One web server 106 may interact with a large number of client devices 102. Accordingly, each server 106 is typically a high end computer with a large storage capacity, one or more fast microprocessors, and one or more high speed network connections. Conversely, relative to a typical server 106, each client device 102 typically includes less storage capacity, a single microprocessor, and a single network connection.

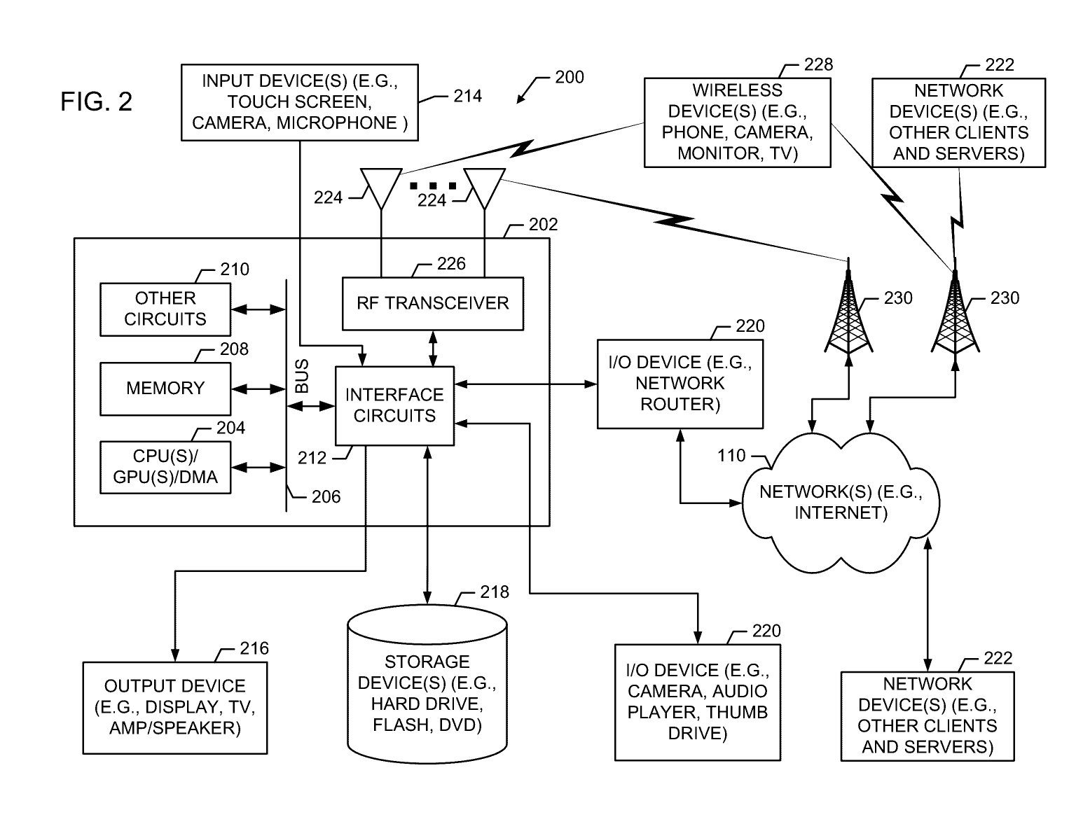

Each of the devices illustrated in FIG. 1 (e.g., clients 102 and/or servers 106) may include certain common aspects of many computing devices such as microprocessors, memories, input devices, output devices, etc. FIG. 2 is a block diagram of an example computing device. The example computing device 200 includes a main unit 202 which may include, if desired, one or more processing units 204 electrically coupled by an address/data bus 206 to one or more memories 208, other computer circuitry 210, and one or more interface circuits 212. The processing unit 204 may include any suitable processor or plurality of processors. In addition, the processing unit 204 may include other components that support the one or more processors. For example, the processing unit 204 may include a central processing unit (CPU), a graphics processing unit (GPU), and/or a direct memory access (DMA) unit.

The memory 208 may include various types of non-transitory memory including volatile memory and/or non-volatile memory such as, but not limited to, distributed memory, read-only memory (ROM), random access memory (RAM) etc. The memory 208 typically stores a software program that interacts with the other devices in the system as described herein. This program may be executed by the processing unit 204 in any suitable manner. The memory 208 may also store digital data indicative of documents, files, programs, web pages, scripts, etc. retrieved from a server and/or loaded via an input device 214.

The interface circuit 212 may be implemented using any suitable interface standard, such as an Ethernet interface and/or a Universal Serial Bus (USB) interface. One or more input devices 214 may be connected to the interface circuit 212 for entering data and commands into the main unit 202. For example, the input device 214 may be a keyboard, mouse, touch screen, track pad, camera, voice recognition system, accelerometer, global positioning system (GPS), and/or any other suitable input device.

One or more displays, printers, speakers, monitors, televisions, high definition televisions, and/or other suitable output devices 216 may also be connected to the main unit 202 via the interface circuit 212. One or more storage devices 218 may also be connected to the main unit 202 via the interface circuit 212. For example, a hard drive, CD drive, DVD drive, and/or other storage devices may be connected to the main unit 202. The storage devices 218 may store any type of data used by the device 200. The computing device 200 may also exchange data with one or more input/output (I/O) devices 220, such as network routers, camera, audio players, thumb drives etc.

The computing device 200 may also exchange data with other network devices 222 via a connection to a network 110. The network connection may be any type of network connection, such as an Ethernet connection, digital subscriber line (DSL), telephone line, coaxial cable, wireless base station 230, etc. Users 114 of the system 100 may be required to register with a server 106. In such an instance, each user 114 may choose a user identifier (e.g., e-mail address) and a password which may be required for the activation of services. The user identifier and password may be passed across the network 110 using encryption built into the user's browser. Alternatively, the user identifier and/or password may be assigned by the server 106.

In some embodiments, the device 200 may be a wireless device 200. In such an instance, the device 200 may include one or more antennas 224 connected to one or more radio frequency (RF) transceivers 226. The transceiver 226 may include one or more receivers and one or more transmitters operating on the same and/or different frequencies. For example, the device 200 may include a blue tooth transceiver 216, a Wi-Fi transceiver 216, and diversity cellular transceivers 216. The transceiver 226 allows the device 200 to exchange signals, such as voice, video and any other suitable data, with other wireless devices 228, such as a phone, camera, monitor, television, and/or high definition television. For example, the device 200 may send and receive wireless telephone signals, text messages, audio signals and/or video signals directly and/or via a base station 230.

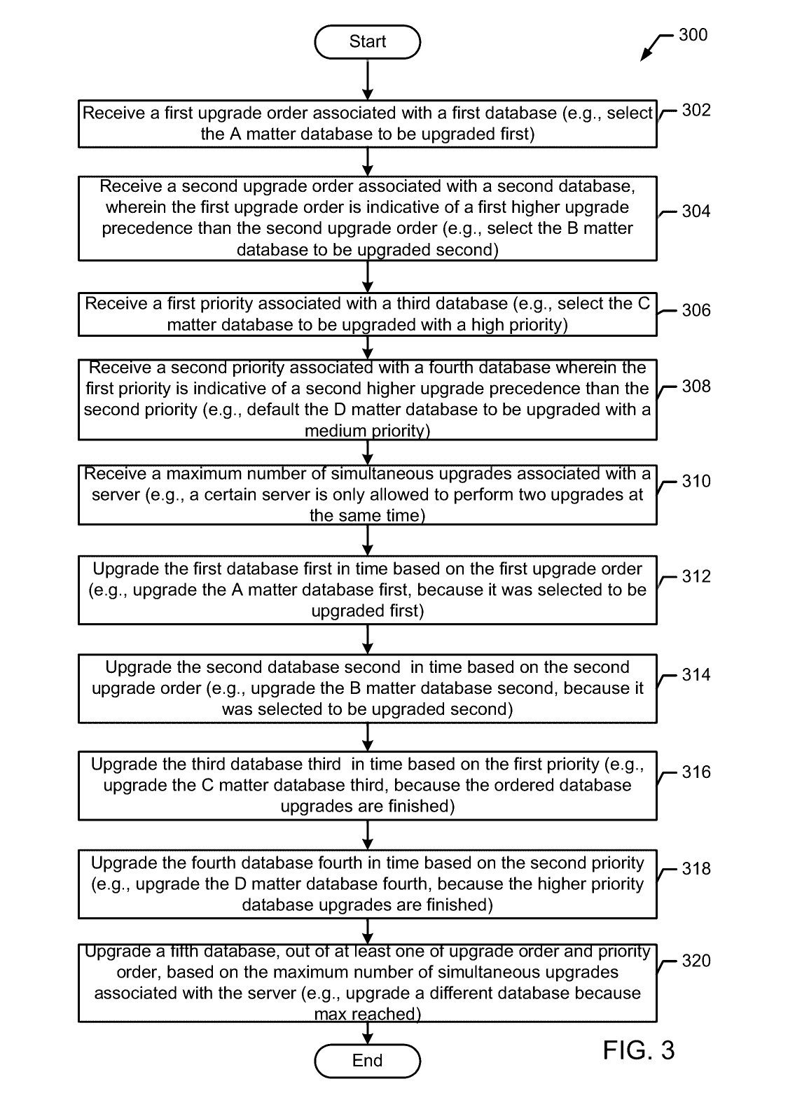

FIG. 3 is a flowchart of an example process for upgrading a plurality of databases. The process 300 may be carried out by one or more suitably programmed processors, such as a CPU executing software (e.g., block 204 of FIG. 2). The process 300 may also be carried out by hardware or a combination of hardware and hardware executing software. Suitable hardware may include one or more application specific integrated circuits (ASICs), state machines, field programmable gate arrays (FPGAs), digital signal processors (DSPs), and/or other suitable hardware. Although the process 300 is described with reference to the flowchart illustrated in FIG. 3, it will be appreciated that many other methods of performing the acts associated with process 300 may be used. For example, the order of many of the operations may be changed, and some of the operations described may be optional.

In this example, the process 300 begins the system receives a first upgrade order associated with a first database (block 302). For example, a user may select the A database to be upgraded first. The system then receives a second upgrade order associated with a second database, wherein the first upgrade order is indicative of a first higher upgrade precedence than the second upgrade order (block 304). For example, the user may select the B database to be upgraded second.

The system then receives a first priority associated with a third database (block 306). For example, the user may select the C database to be upgraded with a high priority. The system then receives a second priority associated with a fourth database wherein the first priority is indicative of a second higher upgrade precedence than the second priority (block 308). For example, the system defaults the D database to be upgraded with a medium priority. The system then receives a maximum number of simultaneous upgrades associated with a server (block 310). For example, the user indicates that a certain server is only allowed to perform two upgrades at the same time.

The system then upgrades the first database first in time based on the first upgrade order (block 312). For example, the system upgrades the A database first, because it was selected to be upgraded first. The system then upgrades the second database second in time based on the second upgrade order (block 314). For example, the system upgrades the B database second, because it was selected to be upgraded second. The system then upgrades the third database third in time based on the first priority (block 316). For example, the system upgrades the C database third, because the system has finished upgrading the ordered databases. The system then upgrades the fourth database fourth in time based on the second priority (block 318). For example, the system upgrades the D database fourth, because the system has finished upgrading the higher priority databases. The system then upgrades a fifth database, out of at least one of upgrade order and priority order, based on the maximum number of simultaneous upgrades associated with the server (block 320). For example, the system may upgrade a different database because the maximum number of simultaneous upgrades for a particular server has been reached.

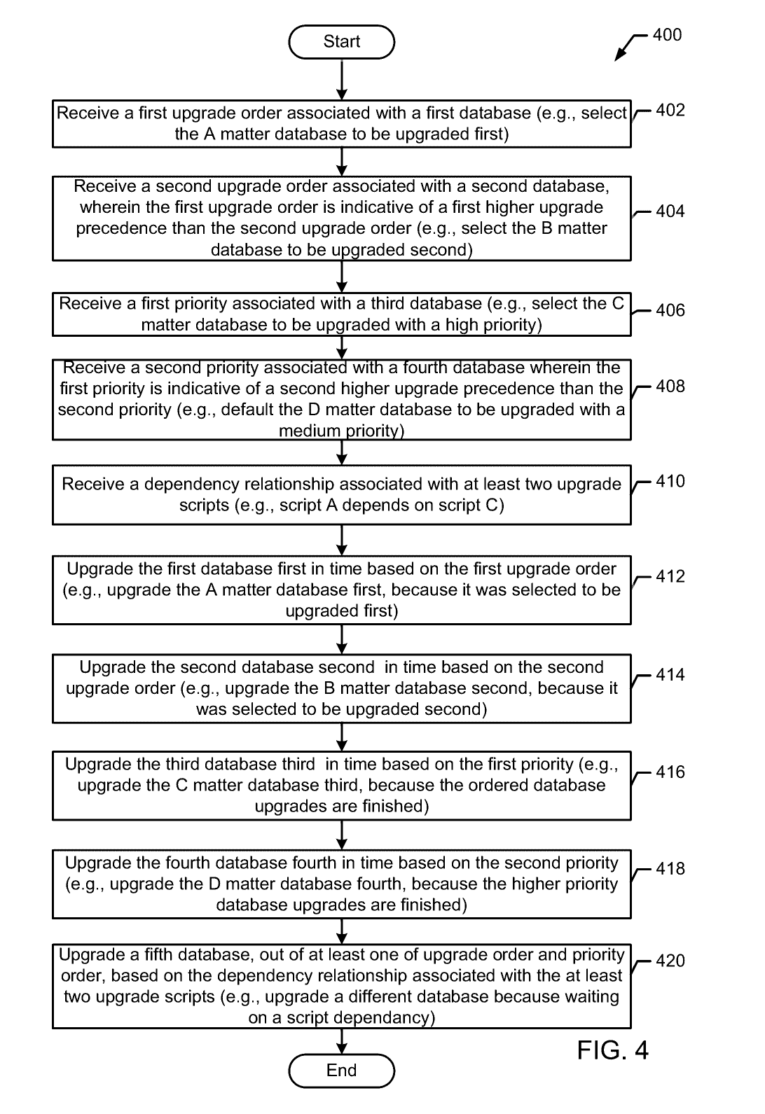

FIG. 4 is a flowchart of another example process for upgrading a plurality of databases. The process 400 may be carried out by one or more suitably programmed processors, such as a CPU executing software (e.g., block 204 of FIG. 2). The process 400 may also be carried out by hardware or a combination of hardware and hardware executing software. Suitable hardware may include one or more application specific integrated circuits (ASICs), state machines, field programmable gate arrays (FPGAs), digital signal processors (DSPs), and/or other suitable hardware. Although the process 400 is described with reference to the flowchart illustrated in FIG. 3, it will be appreciated that many other methods of performing the acts associated with process 400 may be used. For example, the order of many of the operations may be changed, and some of the operations described may be optional.

In this example, the process 400 begins when the system receives a first upgrade order associated with a first database (block 402). For example, a user may select the A database to be upgraded first. The system then receives a second upgrade order associated with a second database, wherein the first upgrade order is indicative of a first higher upgrade precedence than the second upgrade order (block 404). For example, the user may select the B database to be upgraded second.

The system then receives a first priority associated with a third database (block 406). For example, the user may select the C database to be upgraded with a high priority. The system then receives a second priority associated with a fourth database wherein the first priority is indicative of a second higher upgrade precedence than the second priority (block 408). For example, the system defaults the D database to be upgraded with a medium priority. The system then receives a dependency relationship associated with at least two upgrade scripts (block 410). For example, the system may automatically determines and/or the user may indicate that script A depends on script C.

The system then upgrades the first database first in time based on the first upgrade order (block 412). For example, the system upgrades the A database first, because it was selected to be upgraded first. The system then upgrades the second database second in time based on the second upgrade order (block 414). For example, the system upgrades the B database second, because it was selected to be upgraded second. The system then upgrades the third database third in time based on the first priority (block 416). For example, the system upgrades the C database third, because the system has finished upgrading the ordered databases. The system then upgrades the fourth database fourth in time based on the second priority (block 418). For example, the system upgrades the D database fourth, because the system has finished upgrading the higher priority databases. The system then upgrades a fifth database, out of at least one of upgrade order and priority order, based on the dependency relationship associated with the at least two upgrade scripts (block 420). For example, the system may upgrade a different database because the system is waiting on a script dependency.

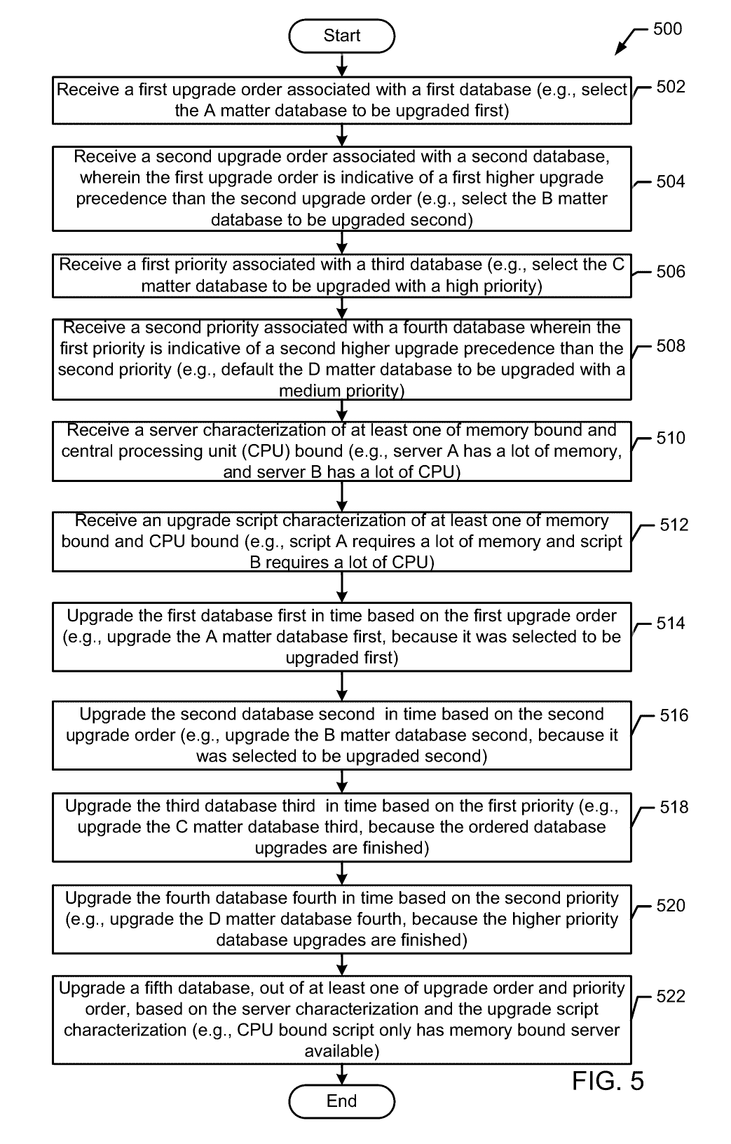

FIG. 5 is a flowchart of another example process for upgrading a plurality of databases. The process 500 may be carried out by one or more suitably programmed processors, such as a CPU executing software (e.g., block 204 of FIG. 2). The process 500 may also be carried out by hardware or a combination of hardware and hardware executing software. Suitable hardware may include one or more application specific integrated circuits (ASICs), state machines, field programmable gate arrays (FPGAs), digital signal processors (DSPs), and/or other suitable hardware. Although the process 500 is described with reference to the flowchart illustrated in FIG. 3, it will be appreciated that many other methods of performing the acts associated with process 500 may be used. For example, the order of many of the operations may be changed, and some of the operations described may be optional.

In this example, the process 500 begins when the system receives a first upgrade order associated with a first database (block 502). For example, the user may select the A database to be upgraded first. The system then receives a second upgrade order associated with a second database, wherein the first upgrade order is indicative of a first higher upgrade precedence than the second upgrade order (block 504). For example, the user may select the B database to be upgraded second.

The system then receives a first priority associated with a third database (block 506). For example, the user may select the C database to be upgraded with a high priority. The system then receives a second priority associated with a fourth database wherein the first priority is indicative of a second higher upgrade precedence than the second priority (block 508). For example, the system defaults the D database to be upgraded with a medium priority. The system then receives a server characterization of at least one of memory bound and central processing unit (CPU) bound (block 510). For example, the user indicates that server A has a lot of memory, and server B has a lot of CPU capacity. The system then receives an upgrade script characterization of at least one of memory bound and CPU bound (block 512). For example, the user indicates that script A requires a lot of memory and script B requires a lot of CPU.

The system then upgrades the first database first in time based on the first upgrade order (block 514). For example, the system upgrades the A database first, because it was selected to be upgraded first. The system then upgrades the second database second in time based on the second upgrade order (block 516). For example, the system upgrades the B database second, because it was selected to be upgraded second. The system then upgrades the third database third in time based on the first priority (block 518). For example, the system upgrades the C database third, because the system has finished upgrading the ordered databases. The system then upgrades the fourth database fourth in time based on the second priority (block 520). For example, the system upgrades the D database fourth, because the system has finished upgrading the higher priority databases. The system then upgrades a fifth database, out of at least one of upgrade order and priority order, based on the server characterization and the upgrade script characterization (block 522). For example, if a CPU bound script only has a memory bound server available, then a different database is preferably selected for upgrading.

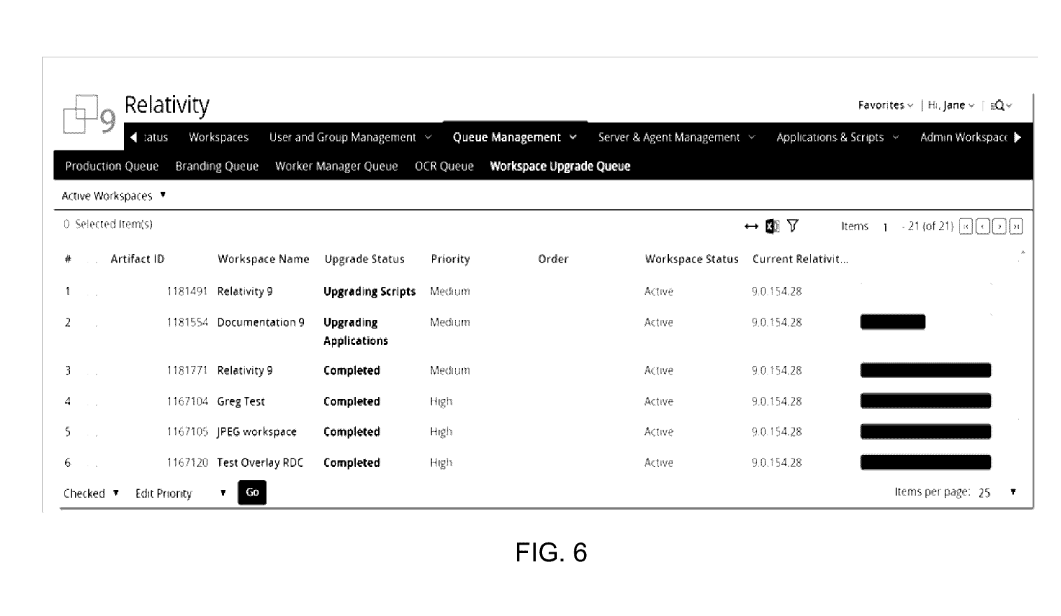

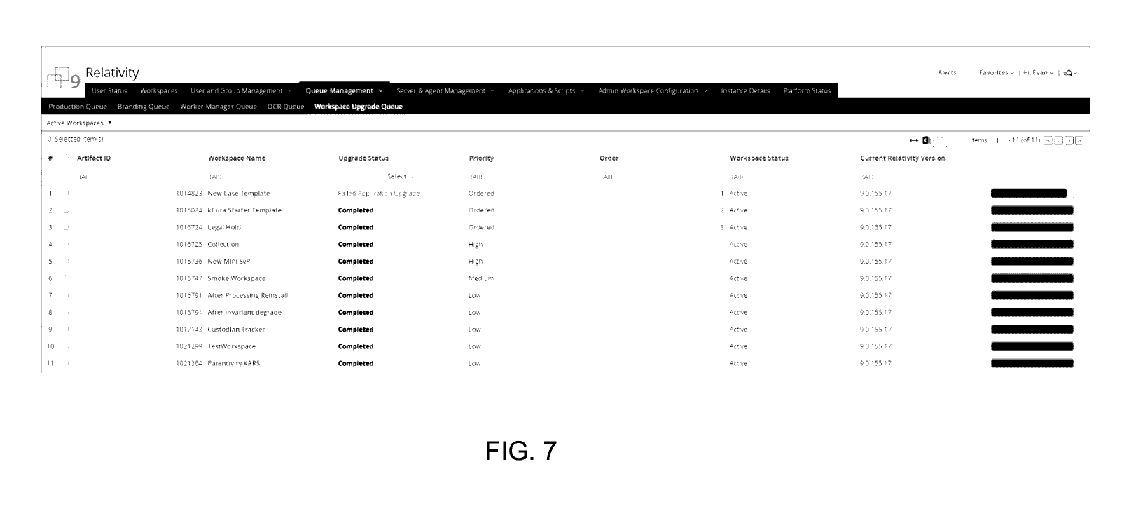

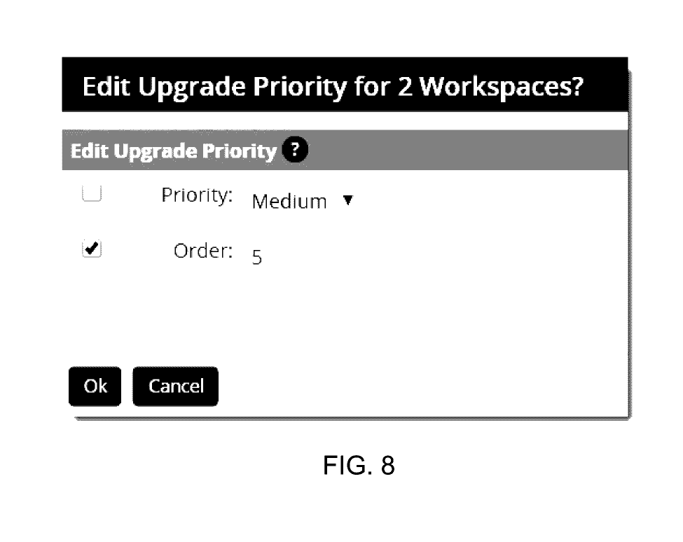

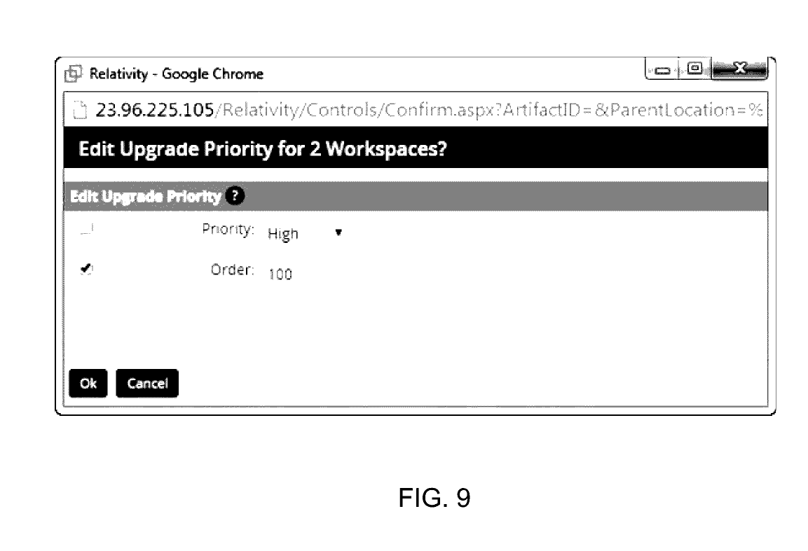

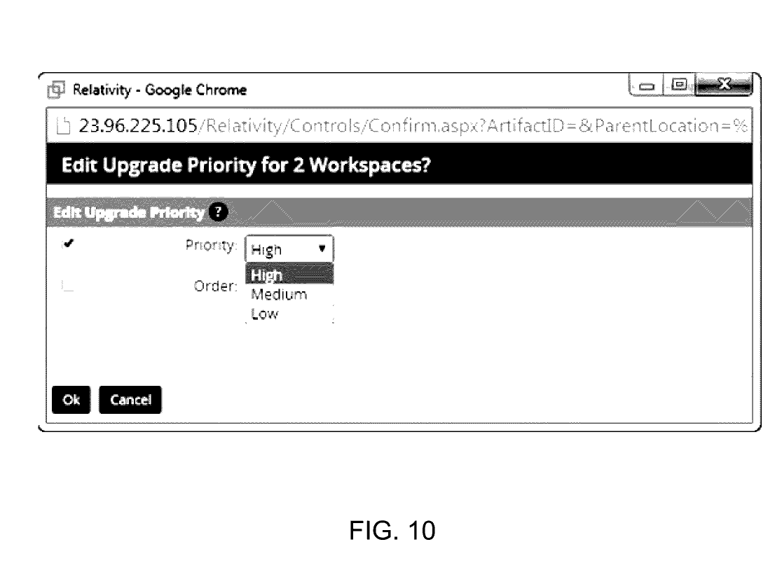

FIG. 6 is a screen shot of an example upgrade order application showing a plurality of database upgrades. In this example, workspace name. upgrade status, priority, order, workspace status, and progress are included. FIG. 7 is a screen shot of an example upgrade order application showing an upgrade order overriding any prioritizations for three databases (e.g., orders 1, 2 and 3 for the first three databases listed). FIG. 8 is a screen shot of an example upgrade order application showing a user setting an upgrade priority. In this example, the user is setting two workspaces to have an upgrade order of five. These example workspaces are to be upgraded after any workspaces with an upgrade order of 1-4. FIG. 9 is a screen shot of an example upgrade order application showing a user setting an upgrade priority. In this example, the user is setting two workspaces to have an upgrade order of one hundred. FIG. 10 is a screen shot of an example upgrade order application showing a user setting a priority. These workspaces are to be upgraded after any workspaces with an upgrade order and before any workspaces with a priority of medium or lower. In this example, the user is setting two workspaces to have an upgrade priority of high.

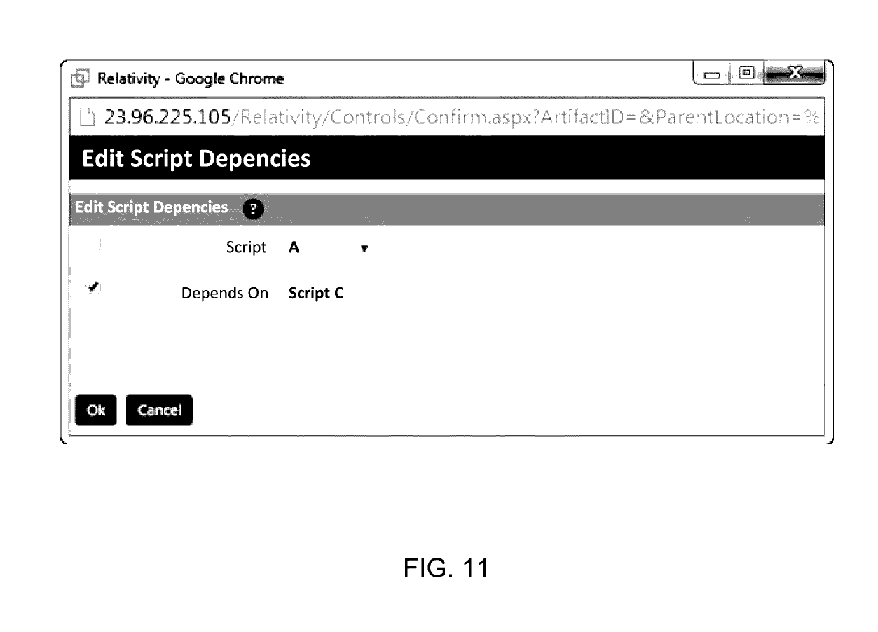

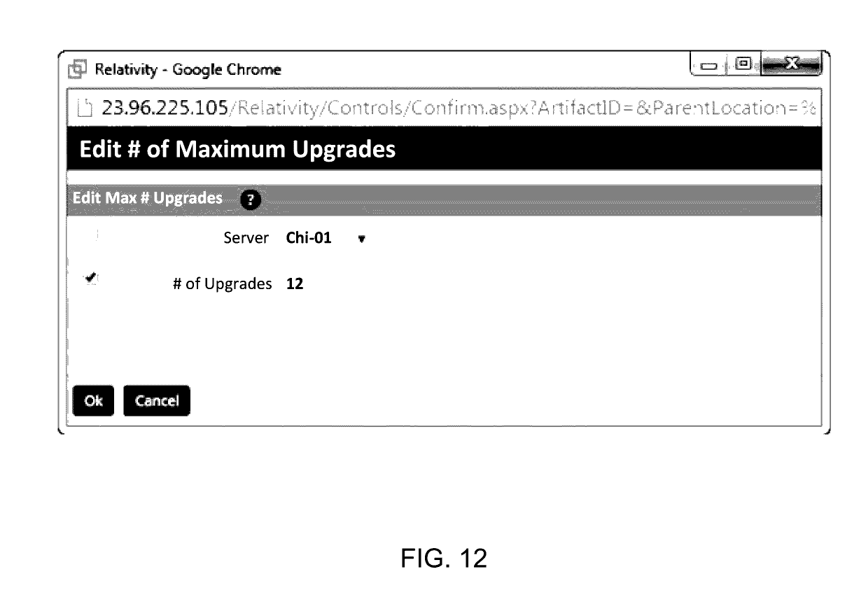

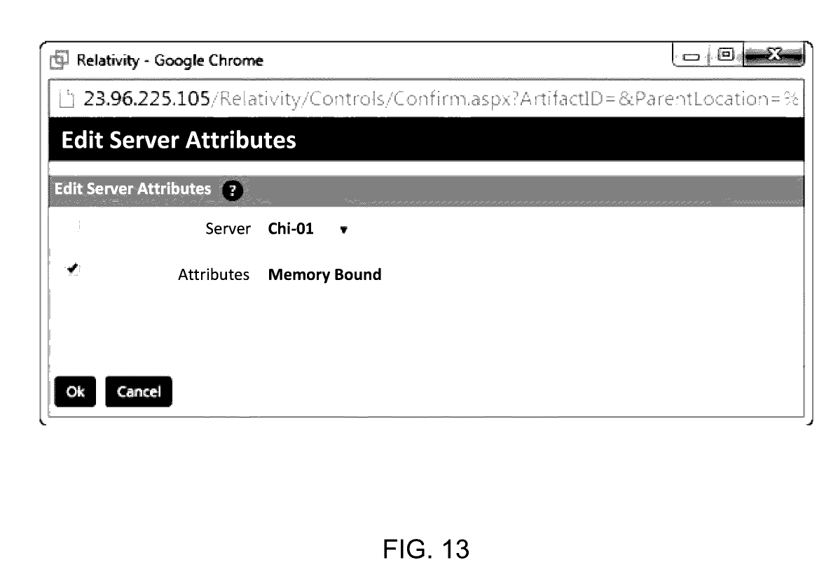

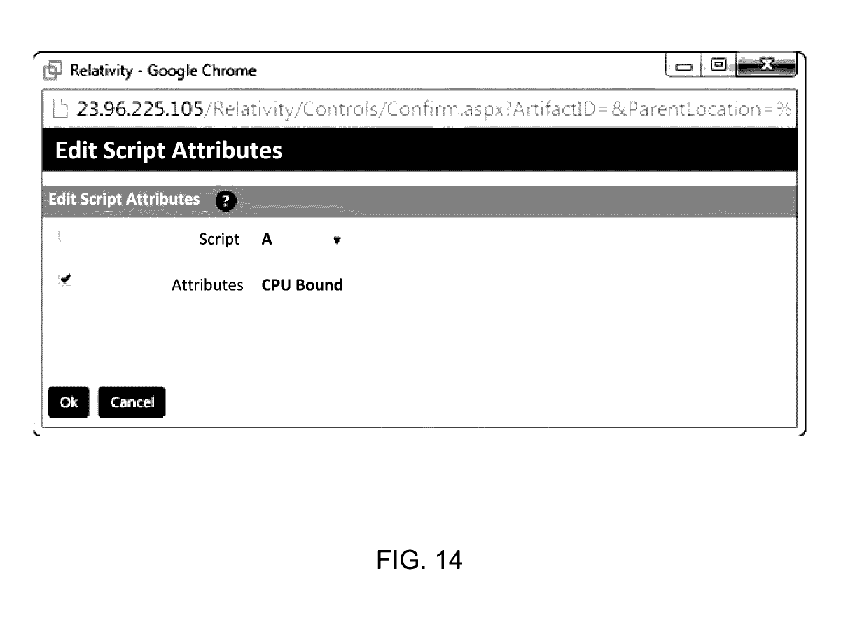

FIG. 11 is a screen shot of an example upgrade order application showing a script dependency. In this example, the user is indicating that script A depends on script C. Accordingly, script A takes precedence over script C. FIG. 12 is a screen shot of an example upgrade order application showing a maximum number of upgrade for a particular server. In this example, the user is indicating that server Chi-01 is allowed to service a maximum of twelve simultaneous upgrades. FIG. 13 is a screen shot of an example upgrade order application showing a particular server being memory bound. In this example, the user is indicating that server Chi-01 is memory bound. FIG. 14 is a screen shot of an example upgrade order application showing a particular server being memory bound. In this example, the user is indicating that script A is CPU bound. Accordingly, workspace upgrade orders are preferably designated out of order and/or priority (if necessary) such that memory intensive upgrades are not assigned to memory bound server and CPU intensive upgrades are not assigned to CPU bound servers.

In summary, persons of ordinary skill in the art will readily appreciate that methods and apparatus for upgrading a plurality of databases have been provided. The foregoing description has been presented for the purposes of illustration and description. It is not intended to be exhaustive or to limit the invention to the exemplary embodiments disclosed. Many modifications and variations are possible in light of the above teachings. It is intended that the scope of the invention be limited not by this detailed description of examples, but rather by the claims appended hereto.

What is claimed is:

1. A method of upgrading a plurality of databases, the method comprising:
receive a first upgrade order associated with a first database;
receive a second upgrade order associated with a second database, wherein the first upgrade order is indicative of a first higher upgrade precedence than the second upgrade order;
receive a first priority associated with a third database;
receive a second priority associated with a fourth database wherein the first priority is indicative of a second higher upgrade precedence than the second priority;
receive a server characterization of at least one of memory bound and central processing unit (CPU) bound;
receive an upgrade script characterization of at least one of memory bound and CPU bound;
upgrade the first database first in time based on the first upgrade order;
upgrade the second database second in time based on the second upgrade order;
upgrade the third database third in time based on the first priority;
upgrade the fourth database fourth in time based on the second priority; and
upgrade a fifth database, out of at least one of upgrade order and priority order, based on the server characterization and the upgrade script characterization.

2. The method of claim 1, wherein receiving the server characterization includes receiving the server characterization manually via a user interface.

3. The method of claim 1, wherein receiving the server characterization includes automatically determining the server characterization.

4. The method of claim 3, wherein receiving the server characterization includes overriding the automatically determined server characterization manually via a user interface.

5. The method of claim 1, wherein receiving the upgrade script characterization includes receiving the upgrade script characterization manually via a user interface.

6. The method of claim 1, wherein receiving the upgrade script characterization includes automatically determining the upgrade script characterization.

7. The method of claim 3, wherein receiving the upgrade script characterization includes overriding the automatically determined upgrade script characterization manually via a user interface.

8. The method of claim 1, further comprising upgrading a sixth database out of upgrade order to facilitate avoiding unused computational resources.

9. The method of claim 1, further comprising upgrading a sixth database out of priority order to facilitate avoiding unused computational resources.

10. The method of claim 1, wherein receiving the first priority includes receiving data indicative of one of three priority levels.

11. The method of claim 10, wherein receiving the second priority associated with the fourth database includes receiving the second priority by default.

12. The method of claim 11, wherein receiving the second priority by default includes associating a middle of the three priority levels with the fourth database.

13. The method of claim 1, wherein upgrading the first database includes retrieving a script to modify a database schema.

14. The method of claim 1, further comprising receiving data indicative of a number of agents to be assigned to at least one of upgrading the first database, upgrading the second database, upgrading the third database, and upgrading the fourth database.

15. The method of claim 1, further comprising sending data indicative of at least a portion of a graphical user interface allowing a user to monitor an upgrade status.
